(19) United States
(12) Patent Application Publication
(10) Pub. No.: US 2015/0012431 A1
(43) Pub. Date: Jan. 8, 2015

(54) METHOD AND SYSTEM FOR PERFORMING TRANSACTIONS BETWEEN BUYERS AND SUPPLIERS

(71) Applicants: Fernando Gomez De Sebastian, (US); Jose Maria Gomez Beneitez, Simancas (Valladolid) (ES); Isabel Gomez Beneitez, Simancas (Valladolid) (ES); Maria Beneitez Redondo, Simancas (Valladolid) (ES)

(72) Inventors: Fernando GOMEZ DE SEBASTIAN, Simancas (Valladolid) (ES); Jose Maria GOMEZ BENEITEZ, Simancas (Valladolid) (ES)

(21) Appl. No.: 13/935,917

(22) Filed: Jul. 5, 2013

(51) Int. Cl. G06Q 20/38; G06Q 20/10

(52) U.S. Cl. CPC G06Q 20/382; G06Q 20/10
USPC 705/44

(57) ABSTRACT

Method and system for performing transactions between buyers and suppliers, which by means of a transactions server centralise and supervise each one of the phases involved in the complete transactions, guarantying that an order made by a buyer to a supplier and a carrier is paid for and guarantying that the buyer does not pay the supplier and carrier until he has received the order under the agreed conditions. The process is completely automatic and establishes condition of sale and timeframes, which may be negotiated between the parties but which, once agreed, become binding for all parties concerned. The lender awards purchase credits to the buyers, so that once the agreed conditions and timeframes have been fulfilled, the corresponding payments may be made automatically.

### OBJECT OF THE INVENTION

The present invention, as formulated in this descriptive specification, refers to a method and to a system for performing transactions between buyers and suppliers, which additionally involves a lender and a carrier. The method and system described herein, in which each one of the phases involved in the complete transactions is centralised in and supervised from a transactions server, guarantees that an order made by a buyer to a supplier and a carrier, is paid for and that when the buyer has received the goods and the carrier has completed his service related to this order, automatic payment is subsequently made. It furthermore guarantees that the buyer does not pay the supplier and carrier until he has received the order under the agreed conditions. This provides complete protection for all the respective parties involved and consequently creates absolute trust on the buyer's, supplier's and carrier's behalves, a true “reliable chain” being fostered between them. The process is completely automatic and establishes condition of sale and timeframes, which may be negotiated between the parties but which, once agreed, become binding for all parties concerned. This centralisation and vigilation of the fulfilment of the conditions and timeframes for each one of the phases, is carried out completely automatically by the transactions server. The lender awards purchase credits to the buyers, so that once the agreed conditions and timeframes have been fulfilled, the corresponding payments may be made automatically. Furthermore, risk coverage mechanisms have been proposed for the financial entities which finance the buyers, to cover them against possible non-payments of purchase credits, awarded exclusively for purchases made via the transactions server. This method gives the buyer guarantee and penalises those parties failing to comply.

### BACKGROUND OF THE INVENTION

Throughout history, various documents which served and continue to serve as support in purchase agreements between buyers and suppliers have been used. The document which has been sold, used and continues to be used at present is, fundamentally the bill of exchange.

In recent times, another type of purchase agreement document has appeared, i.e. promissory notes, payment saps, etc.

Financing transactions between buyers and suppliers basically occurs because the financial entity advances the invoice amount, in the form of credit. which consists of discounted commercial bills, which the lender assigns to the client, trusting that the client will fulfill this debt acquired to the lender upon maturity. The supplier generates the invoice and the payment document protected by the transaction, usually taking it to the bank and the bank uses these discounted commercial bill facilities to advance the amount, minus the corresponding interest, thereby giving the supplier the necessary finances to operate well as well as giving the client enough time to fulfill the agreed purchase agreement with the supplier.

The interests of the supplier and buyer or client are opposed, since the buyer or client requires a timeframe in which to pay for the goods bought from his supplier, in order to make working capital available, which enables them to develop their productive or commercial process, whilst the supplier also requires reserve funds to facilitate their own operation. Therefore, if the supplier does not receive payment until the tirneframe granted to their buyer or client has elapsed, they will lack these necessary funds.

When the supplier is also a buyer or client, they in turn require that their supplier provides them with a timeframe in which to pay for the goods they buy.

As a result, all parties are bound to one another and need the deferred payable amount awarded to their buyer or client.

With this current operational method, the supplier is obliged to apply conditions or payment timeframes to their buyer or client which give rise to the following circumstances:

A. That the supplier finds themself in the difficult or risky situation of assigning a credit to their buyer or client, in the form of a payment timeframe, in such a way that the supplier is not paid the amount on the invoice sent to the buyer until the agreed payment timeframe has elapsed. Should the debt remain unfulfilled upon the maturity of this payment agreement by the buyer or client, the supplier is negatively impacted.

B. That the supplier imposes cash payment conditions on the buyer or client, in which case various situations may arise:

1) That the buyer or client does not accept these conditions, in which case the supplier loses the order; the supplier is negatively impacted.

2) That the buyer or client accepts these conditions, pays by cheque for the delivery of the goods and the supplier may go without payment: the supplier is negatively impacted.

3) That the buyer or client accepts these conditions and the supplier sends them the goods, trusting that immediately after receiving them, the buyer or client will send them a cheque or pay by transfer. However, should the buyer or client fail to send it, the supplier is negatively impacted.

In case A, except for suppliers who may have their own financing, in the majority of cases bank financing is required. Therefore, a financial entity, such as a bank, will advance the invoice amount charged to the buyer or client to the provider, by means of discounted commercial bill facility, which is still a form of credit. in this case, the bank analyses the supplier and the client and if one of the two do not offer the necessary guarantee, the bank denies the supplier the discounted facility and as a result, the supplier lacks the necessary financing and the supplier is negatively impacted. If the results of the analysis are positive, the bank will assign them a discount facility, which may or may not be enough for their turnover volume. If it is enough, the supplier may in principle declare themselves to be financially uninvolved but if it is not, it will be necessary for the supplier to look for other banks which may offer them this complementary financing. If they are unable to find a bank within a certain degree of immediacy who will grant them this necessary financing, they are headed towards an urgent journey through the financial or banking market in order to resolve their financing problems. If they finally find a financing entity, it is more than likely that they will have to take on higher financial costs. However if they do not find a financing entity, their reserve funds will be impacted negatively, with al the repercussions that may occur in their own agreements with third parties. All of this clearly limits their growth capacity, the supplier is negatively impacted.

The supplier has made a time commitment in managing all of these things, in addition to their indispensable everyday work managing their business. The bank or financial entity who assigned a discounted bills facility to them, advance them the money corresponding to the invoice given to the buyer or client, applying interest depending on the expiry date of the payment. In this way, the supplier has the financing needed in order to operate as usual, for example salary payments, general bill payments, cash payments, etc.

In case B, the supplier limits their market and growth capacity immensely and furthermore lacks absolute payment guarantee in certain circumstance; the supplier thereby being negatively impacted.

Should an invoice sent out by a supplier be met by non-payment upon its maturity, the corresponding amount of which was previously financed by a financial entity or bank, their current account is immediately charged with the amount. If this account contains credit, their reserves are reduced; the supplier is negatively impacted. If the supplier does not have enough credit in their account, it goes overdrawn and the bank applies very high overdraft interest rates; the supplier is negatively impacted. The bank proceeds to reclaim this unpaid amount from both the supplier and the buyer or client. If finally the supplier covers the cost or the buyer or client pays the amount, the situation is saved but if the amount remains unpaid, the bank may take legal action, requesting that assets be seized from the involved parties and being able to bring about insolvency and arrangements with creditors; the supplier and the buyer or client am negatively impacted.

If, following legal action, the bank should find that sufficient funds do not exist or the funds quite simply do not exist, in the end, the bank is negatively impacted.

As a result of the above, the non-payment of an invoice may generate a chain of non-payments which may affect a large number of companies, thus creating a genuine chain of insolvency.

Following the current method, the supplier's problems do not end there; when they receive an order from their buyer or client, with which they have an ongoing risk corresponding to a large amount, which exceeds the risk limit assigned to their buyer or client, they may be submitted to the invisible blackmail of the buyer or client starting a sequence of non-payments on maturing invoices if the supplier does not send the order but, if the supplier does complete the order, the risk with this buyer or client increases, along with the uncertainty about whether or not they will be able to fulfill the high amount of this invoice; the supplier may be negatively impacted.

Moreover, should the product requested in this order have characteristics which are very specific and exclusive to this buyer or client, the risk doubles because the buyer or client may not fulfill their payment agreement and may also cancel the order when the supplier has already prepared it for delivery. In both cases, the supplier faces serious negative impact, in the first case this impact being clear and also in the second case, since although this specific good has not been delivered, it will be very difficult to sell it to a third party and therefore they would store it, freezing reserves and creating dead stock, or make a bad sale, thus losing money. The supplier is negatively impacted.

With the current method, the supplier may not be the only one who is negatively impacted; when clients have to make an advanced payment to their supplier, they have no guarantee of receiving the goods in adequate condition or with the requested characteristics and are not even sure whether or not they will receive the goods. The buyer or client is negatively impacted.

Therefore at times, both individuals and companies may prefer not to attend to the orders of potential buyers because they are worried about not knowing whether or not they will be paid for the good sent or the service delivered in the end, just as potential buyers may not place orders given the lack of trusted suppliers who guarantee the receipt of goods within the agreed conditions.

Document EP1533726 describes a payment method for at least one good, characterized in that a trusted third party (TTP) verifies the seller's name, the authorization and the credit reserve to make the corresponding payment on behalf of the financial institution which financed the buyer. Furthermore, it is characterized in that the payment made by the financial institution to the supplier is not made until the carrier carrying the requested good indicates that the buyer has accepted said good. Nevertheless, the invention described in EP1533729 A1 does not guarantee that, the buyer and supplier having established a series of previously agreed conditions, each one of the transaction phases is fulfilled. Moreover, the method described in this document only concerns the phase in which the good is sent by the seller, the financing entity which finances the buyer being the party responsible for establishing the timeframe in which possible returns may be made.

The present invention focusses specifically on the problem set out above, providing a method and a system through which suppliers may be guaranteed that, provided that they fulfill their conditions and comply with the timeframes and that the good ordered or service offered has been received, that they will always receive payment from the buyer.

### DESCRIPTION OF THE INVENTION

In order to meet the objectives and prevent the abovementioned limitations, the present invention consists of a method and a system for performing transactions between buyers and suppliers, which guarantees that suppliers are paid and that the buyer receives the placed order. All of the above, in accordance with a series of timeframes and conditions, which may be negotiated by the two parties but which once agreed, must be respected by said parties, is supervised and managed from a transactions server which specifically guarantees that the above is fulfilled. A trusted system in which those buyers and suppliers who fulfill their obligations is thus created.

Firstly, the invention is based on substituting the credit granted in financial entities in the form of conventional discounted commercial bill facilities, with Purchase Credit facilities, in the form of credit policies, for exclusive use in purchases made though the transactions server. The transaction charges will be blocked before being paid to the supplier, depending on which phase the transaction is in, by the financial entity against the purchase credit account and depending on those credit facilities granted to the buyer.

This method or system makes it possible to reduce financial costs significantly, since it serves to finance purchases rather than sales, which are obviously worth a higher amount and also as a result, the interest applied.

This method or system is perfectly compatible if the buyer has sufficient funds in their current account and does not request purchase credit. In this case should the lender thereby specify, in the transactions server, the payments of the purchases made will be covered from their purchase account, where the amount to be paid to the supplier will automatically be transferred from their current account. Therefore, the purchase account will operate as the method or system proposes, regardless of whether they have funds coming from a purchase credit or from a current account, in such a way that the amount corresponding to the order will be blocked and deducted from there, according to the transaction phase, as will later be specified. In this case, the buyer would not have any financing costs, given that payment would be made with their own money. The lender will likewise automatically agree to an order placed by the buyer to the supplier, provided that the credit available in their purchase account, protected by current, covers the transaction amount.

Therefore the purchase account may be nourished with the purchase credits granted by the lender or be nourished by the money which the user himself has available in his current account and which the bank will transfer to the purchase account automatically, in accordance with the agreement made with the user, for each purchase transaction or operation.

Therefore a first objective of the invention is a method for performing transactions between buyers and suppliers, which involves at least one buyer, at least one supplier an at least one lender. In order to perform the transaction a transactions server is available, through which, via a user interface, buyers, suppliers and lenders carry out the following method phases:

I) The buyer, supplier, carrier and lender register in a database via the user interface, the interface and database being comprised within the transaction server. This interface, which will preferably be a web page, will only publish information authorized by the registered party, in order to provide user access, the remaining information being strictly confidential and guaranteed by its high security mechanisms.

II) Publishing the registered providers and carriers their catalogue of products, the categories to which they belong, their characteristics, their optional inclusion in videos, photos, drawings, logos, etc. The data may optionally be imported from their own database to a transaction server database.

III) The supplier and carrier establishing their standard conditions of sale and timeframes.

IV) The standard conditions of sale established by the supplier and carrier, according to III), may be selected from at least:
Establishing a payer and payment ratio for the buyer's purchase credit interest, impacting the transactions.
Establishing a transport service contractor,
Establishing a payer and a transport payment ratio for the transport, good or service requested in the order.

The supplier's and carrier's standard conditions may generally be negotiated with the buyer for all of the transactions they will make together in the future, the new agreed conditions being registered in the transactions server. The method and system consider that these agreed conditions may also be amended transaction by transaction in exceptional circumstances, upon mutual agreement between the buyer, supplier and carrier, which are stored associated to this exclusive transaction in the transaction server database.

For example, in a specific transaction, it may be established that it is not the buyer who will pay the total amount of interest on the purchase credits provided by an approved order but rather that this interest will be shared with the supplier, whose account will be charged with these purchase credits.

Likewise, the process may be established for the carrier.

V) The standard timeframes established by the supplier nd carrier, according to III), may be selected from at least:
Establishing a timeframe in which the buyer can agree to a budget generated by the supplier and carrier.
Establishing a delivery timeframe, determined by the supplier, for the order placed by the buyer, which must be agreed to by the buyer,
Establishing a timeframe in which the supplier can agree to the order placed by the buyer.
Establishing a timeframe in which the buyer agree, partially or totally, to good or service delivered by the supplier, through the carrier, reflected in the delivery note,
Establishing a timeframe in which the buyer can return the good to the supplier, effective as of the date the good was delivered by the carrier.
Establishing a timeframe in which the supplier can accept returns made by the buyer.
Establishing a timeframe in which the buyer, supplier and carrier can negotiate non-conformities.

The supplier's and carrier's standard timeframes may generally be negotiated with the buyer, for all transactions which they will make between them in the future, the new agreed conditions being registered in the transactions server. The method or system considers that said agreed timeframes may also be amended on a transaction by transaction basis in exceptional circumstances, upon mutual agreement between buyer and supplier, which are stored associated to this exclusive transaction in the transactions server database.

In a specific transaction for example, it may be established that one of the negotiated and agreed timeframes may be amended, provided that the supplier and buyer agree and that the modifications associated to this exclusive transaction are stored in the transaction server database. Likewise, this process may be established for the Carrier.

The carrier also establishes standard timeframes for his service, selected from at least:
Establishing the timeframe in which the carrier can generate budgets.
Establishing the timeframe in which the supplier can agree to the budgets.
Establishing the timeframe in which the carrier can deliver the goods to the buyer and return the goods to the supplier, according to the type of service contracted. The services and timeframes may optionally be transferred from their own database to the transaction server database.

The carrier's standard timeframes may be negotiated with their (supplier) buyer client, in general or on a transaction by transaction basis and are stored in the database in order to perform the transactions.

An the information on the conditions of sale and timeframes established or agreed to by both parties are stored in the transaction server itself.

Generating buyer, supplier, lender and carrier agreements or non-conformities within said timeframes and the buyer's, supplier's and carrier's failure to comply with the timeframes, regulate actions carried out automatically by the server, in stages which make up the transaction.

The method or system notifies those involved in the maturing of a specific timeframe that said timeframe is close to elapsing. In this way, they are given control over elapsing timeframes, in the various stages of the transaction.

VI) The buyer, supplier and carrier requesting at least one purchase credit, from at least one lender, with whom they will have to previously make available a current account, for an amount and some agreed conditions with the lender. When using these purchase credits, the buyer, supplier and carrier will pay to the financial entity the corresponding interest depending on the amount drawn and the repayment timeframe fixed by both parties, unless the only payment option to have been configured is payment from their current account.

VII) The buyer using the user interface, once the purchase credits have been assigned, to place an order for a good or service to the supplier for an amount less than or equal to the total amounts of the purchase credits assigned to said buyer or to the credit available in the current accounts related with the purchase account. The transactions server will temporarily block the order amount in the purchase account that the buyer used for the transaction. giving the supplier guarantee that he will be paid for the transaction, if he complies with the conditions and timeframes, even when the buyer wishes to cancel the accepted order without prior mutual agreement. The purchase credits assigned may have a specific validity period, in such a way that once the timeframe agreed with the beneficiary has elapsed, they should be renewed at the lender's request.

VIII) The transactions server sending automatic instructions to the lender to pay the supplier a total or partial amount of a delivery, once the conditions of sale have been met or the timeframe established in which the buyer can give partial or total agreement to said delivery has elapsed and subtract the amount paid from the buyer's purchase account credit, which was previously blocked.

This method gives financial guarantee to the supplier and carrier on the accepted order and on being paid almost immediately upon delivery of the good.

The guarantee is acquired because, once agreement between the buyer and supplier exists on the order placed by the buyer, in this case including the carrier's budget, the method or system sends instructions to the lender to block the total amount of the order from the buyers purchase account or the corresponding part to be paid and the corresponding amount to be paid from the supplier's purchase account, depending on the conditions agreed between the buyer and supplier in relation to who pays the purchase interest and in what percentage and who pays the carrier and in what percentage.

Therefore, the transactions server gives buyers, suppliers, lenders and carriers all the necessary support so that, all of them being previously registered in said server, it is possible for them to perform trustworthy transactions and promises to incentivize the market and contributes to making economic flow and the economy on the whole and in turn, the labor market, more dynamic.

It is important to note that the buyer must only cover lender payments when each purchase credit available in the transactions expires. Those purchase credits not used by the buyer within a specific, specifically agreed timeframe, will expire and may incur a cost, the existence and amount of which has been previously agreed.

Furthermore, the buyer could request that the lenders increase the amount of previously assigned purchase credits or even apply for new purchase credits from other lenders via the transactions server. These financial entities may be banks, investment funds, companies, individuals or similar.

In certain transactions, it may be necessary to involve a carrier to deliver the order placed by the buyer. The carrier, who will be selected via the server interface, will also have previously registered in the transactions server and should have applied for and have one or various purchase credit accounts which will correspond to his own purchases and to the agreements made with his buyer or client.

The carrier therefore acts like an additional supplier and the service offer contractor which selected the carrier acts like an additional buyer. This process is applied to all phases of the method described herein. Therefore, it concerns an additional transaction within the main transaction.

Similarly, the carrier will offer a catalogue of services with their characteristics, which will be registered in the server, alongside conditions of sale and specific timeframes, as described above.

Once the service has been delivered and the timeframes complete, the carrier contractor, will send the lender an instruction to pay the carrier, using the purchase account of the person who contracted him. It is important to highlight that the transactions server will respect the agreements made between the buyer and supplier in their conditions, in relation to who will pay the transport and in what percentage, reflected in the accepted order itself, in such a way that the transactions server will give instructions to the lender to previously block and subsequently pay the carrier, from the buyer's purchase account, from the supplier's purchase account or from both accounts and finally, the amount to be charged to each one of them.

The interface used by the transactions server will preferably be a web page via which all the parties involved in the transactions will interact.

In one particular embodiment, the stages forming the transaction are selected from at least:
An budget generation stage
An order generation stage
A delivery note generation stage
An order transportation stage
An invoice generation stage
A combination of the above

Failure to comply with the conditions of sale, specifically the timeframes established, which are always regulated by the transactions server, will automatically generate a series of instructions which will entail:
Automatically blocking and unblocking a transaction temporarily, partially or in whole.
Automatically paying the transaction in part or in whole.
Dismissing the transaction.

In another particular embodiment, the method proposes that extensions will be established in any of the timeframes of the conditions of sale via the transactions server, as previously agreed by the buyer and supplier.

In a further particular embodiment of the invention, following an order having been placed by the buyer and the supplier having generated a budget, the transactions server checks that the buyer and supplier agree totally or partially to the budget within the timeframe for accepting the budget. Following this, it validates the part of the budget accepted by the buyer and supplier, storing this part of the budget in the transactions server database and generates an order on behalf of the party agreed to the budget.

It may be that after the supplier having generated a budget, the buyer is only interested in the proposed part of the order and therefore only partially agrees to said budget, following which the supplier would also have to agree to said partial budget.

In an additional particular embodiment, if the buyer or supplier fails to comply with the timeframe in which to accept the budget, the transactions server deletes the budget.

In a further additional particular embodiment of the invention, having confirmed acceptance of a budget and generated the corresponding order, if the timeframe in which to deliver the order placed is not complied with, a timeframe previously agreed to by the buyer and supplier: the transactions server deletes the transaction and blocks the corresponding amount in the buyers purchase account, which was previously blocked.

When the carrier receives a budget request from a contractor of the service that he provides, the following data, amongst other things, would be contained therein:

Product type

Volume

Weight

Pick-up address

Delivery address

Type of service contracted—selected from those offered by the carrier.

This information should serve to enable the carrier to facilitate the budget. The carrier should or should not agree, as this is why the request has been made.

The carrier will have the timeframe for facilitating the budget to the contractor which is published in his conditions and timeframes, except those changes agreed by both parties.

If the budget is agreed to by the applicant, the budget will become a set order. Then the transactions server, by means of its interface, will reflect this amount in the order that the buyer placed to the supplier, where the carrier data—the data indicated above—the service charge and who will pay and in what percentage—according to that which was agreed by the buyer and supplier, will be reflected clearly and in a separate space. The transactions server will consider the person who pays and in what percentage in order to block the corresponding purchase account or accounts, thus also guaranteeing that the carrier is paid for the service delivered.

When the good is ready, the supplier will inform the carrier via the transactions server interface, so that he can collect and deliver it. The carrier shall comply with the conditions and timeframes agreed in the order and the transactions server will control them automatically.

The carrier will use mobile devices to indicate the collection date and the delivery date; the transactions server will check that the conditions and timeframes have been complied with, sending an instruction to the lender to pay the carrier for his service.

When there are variations in the agreed conditions and timeframes, the transactions server will keep the amount blocked in the purchase account of the person who requested the service but will not give payment instructions until conformation is not received from the person who requested the order.

Should the carrier's failure to comply have had some kind of negative impact, the method or system will always consider a possible negotiation between the parties, in order to come to a new conformity agreement, which is reflected in the transactions server interface, in order to proceed to send instructions to the lender to pay the carrier of the transaction for the service he delivered, which was previously blocked.

In another particular embodiment of the invention, when an order has been placed without a budget having been previously approved, the transactions server tests the total or partial conformity of the order on the buyer's and supplier's part within the timeframe for accepting the order and validates the approved part of said order, blocking the amount of the approved part in the buyer's purchase account. No purchase accounts are blocked at all when mutual conformity does not exist. In addition, said approved part is stored in the transaction server database.

In a further particular embodiment of the invention, an order having been placed without a budget having previously been confirmed, the supplier's failure to comply with the timeframe for accepting the order will result in the transactions server deleting the transaction.

In an additional particular embodiment of the invention, the transactions server tests the total or partial conformity of the buyer to the delivery note within the timeframe for accepting the delivery note. The transactions server validates the part of the delivery note accepted by the buyer, storing it in the data base of the server itself. At the same time, the transactions server automatically sends instructions to the lender to pay the supplier the amount corresponding to said accepted part of the delivery and subtracts the amount corresponding to the accepted part of the delivery note, from the buyer's purchase account, which was previously blocked. In addition, it keeps the amount corresponding to the part of the delivery note not accepted by the buyer blocked in their purchase account.

In contrast, should the buyer fail to comply with the timeframe for accepting the delivery note, the transactions server will validate the total of the delivery note and will store it in the database. At the same time, the transactions server sends instructions to the lender to pay the supplier the total amount of the delivery note and subtracts said amount from the buyer's purchase account, which was previously blocked. This gives the supplier guarantee that he will be paid the amount corresponding to the order made, provided that he complied by sending the same within the established timeframes.

In another embodiment of the invention, when, after the buyer having received the order he placed, he does not give total or partial conformity to the delivery note and makes a total or partial return of the good or service delivered, within the established returns timeframe, the transactions server, after having tested the supplier's conformity to the return within the timeframe for accepting returns, cancels the transaction partially or totally. At the same time, the transactions server unblocks the amount corresponding to the good or service returned, in the buyer's purchase account, which was previously blocked. In this case, it is not foreseen that the supplier returns the part of the goods received but rather that the buyer returns part or all of the goods received and does not pay the supplier for this returned part.

Therefore, should the buyer make a partial or total return of the goods received with a replacement request, the supplier should once again offer the returned good, within the timeframe agreed by the parties involved in this replacement. After checking the conformity of the supplier with the return within the timeframe for accepting the return, the transactions server keeps the amount in the purchase account which was previously blocked temporarily blocked, this amount corresponding to the non-approved good or service returned (the return) and the buyer agrees to the delivery note of the good or service which has been offered once again within the timeframe for accepting the delivery note. Once received, the transactions server sends an instruction to the lender to pay this part of the order which was previously blocked.

In another embodiment of the invention, should the buyer fail to conform to the timeframe for making returns or, in other words, fail to inform the transaction server of his non-acceptance of the order received within the timeframe in which to make returns, the transactions server sends instructions to the lender to pay the supplier the total amount of the delivery note, automatically subtracting it from the buyer's blocked purchase credit account.

Should the buyer wish to make a return outside the established returns timeframe which was previously agreed with the supplier, this return shall be treated as a role reversal transaction, in which the original supplier becomes the new buyer and the original buyer becomes the new supplier, the method or system processing it in the same way as set out above.

The method has also been proposed before the existence of irreconcilable non-conformities between the buyer and supplier, when the timeframe within which to negotiate the non-conformity, which was previously established in the conditions of sale has elapsed. The method activates the intervention of a person skilled in the art whose ruling both buyer and supplier promise to obey. This makes it possible to resolve conflicts which may arise between buyers and sellers throughout various transactions which may be performed. Clearly, the parties involved in the conflict in the latter instance may always resort to the Courts of Justice.

Equally, it is proposed that the transactions server calculates the above mentioned timeframes based on the date selected from at least:
The date in which the buyer, supplier, carrier and lender introduces a conformity or non-conformity.
The date which a budget, order, pick-up and order delivery, return or re-offer are generated.
An expiry date for a previous timeframe.

In order to track the transactions carried by the transaction server, said transactions server assigns a unique identification code to each transaction, which is applied in each of the corresponding phases composing said transaction.

The present method also proposes that when the buyer has been assigned with more than one purchase credit, associated to a lender, a previous phase to placing an order would be selecting the portion of the amount of the order which would charge to each purchase credit. Therefore, the amount of the order may be charged just in one purchase credit or in various purchase credits. If it is charged in various purchase credits, the transactions server should indicate, via its interface, which lenders it selects and the percentage of the amount which, or which concrete amount would charge in each credit purchase. The method or system would automatically calculate, if preselected in this way, the percentage of an order to be applied to each purchase credit selected, depending on the proportional division of the total order amount in relation to the total purchase credits available, corresponding to the lenders selected.

Creating a coverage fund for the financial entities lending the purchase credits which are awarded individually to each user has been considered in the present method or system. This coverage fund can be considered as an insurance policy which is nourished on the one hand by a fixed percentage which is automatically subtracted from the amount payable to the supplier in each one of the transactions and optionally, on the other hand by the lender himself, in such a way that each financial entity would have greater or lesser coverage for each one of the individually awarded purchase credits, depending on the contribution each one makes to the fund. The amount of coverage and its cost will also depend on the classification that the entity managing said coverage each beneficiary makes to a purchase credit.

The method also proposes that invoices may be generated from the server (the user may optionally assign their own identification number to the invoices issued) prior to one of the parties requesting it or even automatically. If this option has been selected, the buyer, supplier and carrier would all be granted access.

A second objective of the present invention is the system used to perform the method described herein. Said system comprises a transactions server, which in turn comprises, at least:
A storage database to store information on at least the buyers, suppliers, lenders and carriers who are registered, the conditions of sale and timeframes established by each one of these parties, purchase credits, status and record of each one of the transaction phases, also including catalogues of goods and services the suppliers and carriers have to offer.
   A user interface through which the buyers, suppliers, lenders and carriers interact with the transactions server.
   A central processor.
   A central memory, linked to a central processor, which comprises a series of instructions which when carried out by a central processor, make said processor run each and every one of the phases in the method set out above.

Non-transitory computer readable medium have also been proposed, which stores thereon a program that causes a computer to execute instructions in order to carry out the method in order to perform transactions between buyers and suppliers as described above.

### BRIEF DESCRIPTION OF THE DRAWINGS

FIG. 1—It is shown a flow diagram of the current, state of the art method for performing transactions between buyers and suppliers, in which the solvency of the transactions is not guaranteed, thereby giving rise to a potential chain of non-payments.

FIG. 2—It is shown a flow diagram of the method or system object of the present invention, in which solvency is guaranteed via a transaction server, with significant financial cost reductions for those registered in this innovative method and system.

### DESCRIPTION OF VARIOUS EXAMPLE EMBODIMENTS OF THE INVENTION

Below is an illustrative, non-limiting description of various example embodiments of the invention, with reference to the numbering employed in the figures.

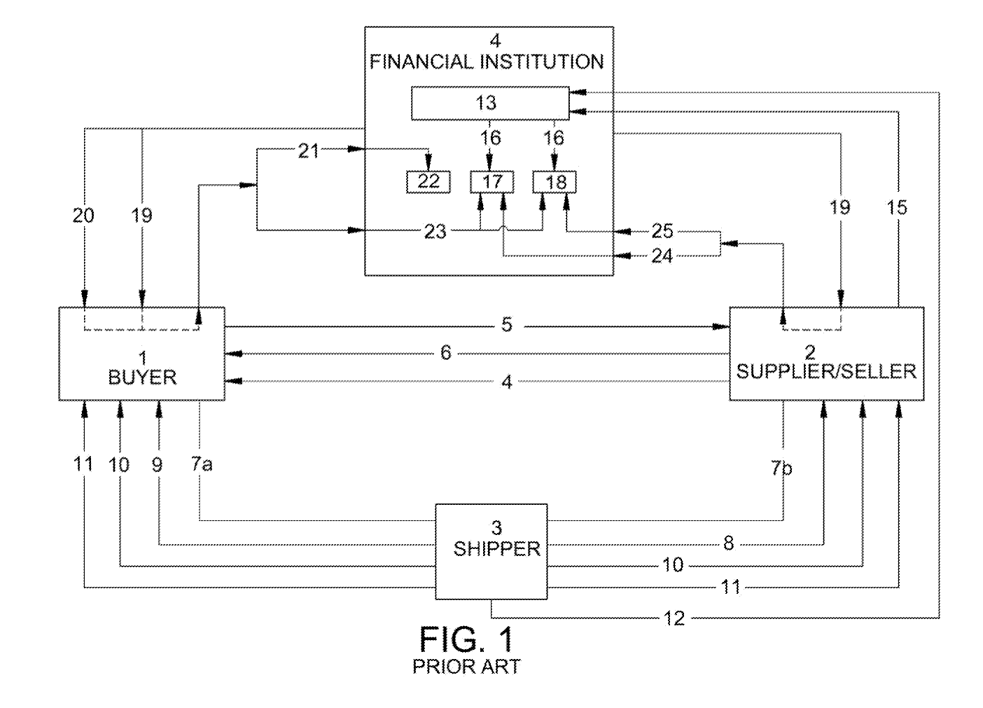

FIG. 1 is a flow diagram representing the most general aspects of the transactions performed between buyers and suppliers, which are currently being used. In this specific example, a carrier (3) was involved in delivering the requested goods from the supplier (2) to the buyer (1). Thus, the buyer (1) places an order (5) with the supplier (2) which will be optionally confirmed (6) by said supplier (2).

Therefore, either the buyer (1) entrusts (7a) the carrier (3) to deliver the good or it is the supplier (2) who entrusts (7b) the carrier (3) with said delivery. The carrier (3) picks up the goods corresponding to the order (8) together with the delivery note (10), from the supplier (2) and transports it, delivering it (9) to the buyer (1), acknowledging receipt of the good by means of signing the delivery note (10).

The carrier (3) subsequently delivers the delivery note (10) signed by the buyer (1) to the supplier (2). The supplier (2) will send an invoice (14) based on the delivery note (10) to the buyer (1) and will send a shipment note (15) to the bank (4) in the form of a bill of exchange, promissory note or others, so that it is paid into (16) their account (18), charged with the discounted commercial bills facility (13) which said bank (4) has assigned to the supplier (2).

Depending on who contracted the carrier services (3), the carrier (3) generates an invoice (11) which he will send to the buyer (1) or supplier (2). The carrier will subsequently send a shipment notice (12) to the bank in the same way as in the case set out above, attaching the payment agreement document such as a bill of exchange, promissory note or others, corresponding to the invoice generated for the service delivered, to the financial entity (4), for example a bank, so that it is paid into (16) his account (17), charged with the discounted commercial bills facility (13) that said bank (4) has assigned to the carrier (3).

With sufficient advance notice, the bank (4) produces payment expiration notices (20) which it sends to the supplier (2) so that they may express their conformity or non-conformity with the payment or the bank notes or promissory notes, which were subtracted or financed by the bank (4) to the supplier (2) in due course and which correspond to the invoice for the material delivered to the buyer (1) and. On the other hand the bank (4) produces payment expiration notices (19) which are sent to the supplier (2) or the buyer (1) according to who contracted the carrier service (3) so that they may express their conformity or non-conformity with paying the bank notes or promissory notes which were subtracted or financed by the bank (4) to the carrier in due course and which correspond to the carriers (3) service invoice (11).

In view of the above, both the buyer (1) and supplier (2) have the option not to pay the bank notes or promissory notes received and may thereby start a chain of non-payments.

When the buyer (1) receives the payment expiration notices for the bank notes or promissory notes corresponding to the invoice amount of the order placed with the supplier (2), should the buyer (1) give payment order to the bank (4), they will credit (21) their account (22) and absolve said amount from the supplier's (2) discounted bills facility (13). However, if the buyer (1) does not give payment order, the bank (4) will then credit (23) the supplier's (2) account (18). If the supplier does not have sufficient credit in their account (18), the bank (4), who had previously financed or subtracted the expired amount, is negatively impacted and reclaims said amount from both the supplier (2) and the buyer (1).

When it is the buyer (1) or supplier (2) who receive the bank note or promissory note (19) expiration notice, corresponding to the transportation service, if payment order is given, the amount is credited (21) or (25) either in the buyer's (1) account (22) or in the supplier's (2) account (18). However if no payment order is given, the bank (4) then credits the account (17) of the carrier (3) with said bank note or promissory note amount. If the carrier does not have sufficient credit in his account (17) the bank (4), who had previously financed or subtracted the expired amount, is negatively impacted and reclaims both from the buyer (1) or supplier (2) who contracted the service and from the carrier (3). In both cases, non-payment by the buyer or supplier may give rise to a chain of non-payments to third parties or the non-payment of salaries to their own employees, which may sometimes even lead to companies collapsing, with all the known economic repercussions associated with it. All of these things are usually managed by conventional means such as fax, telephone or ordinary mail.

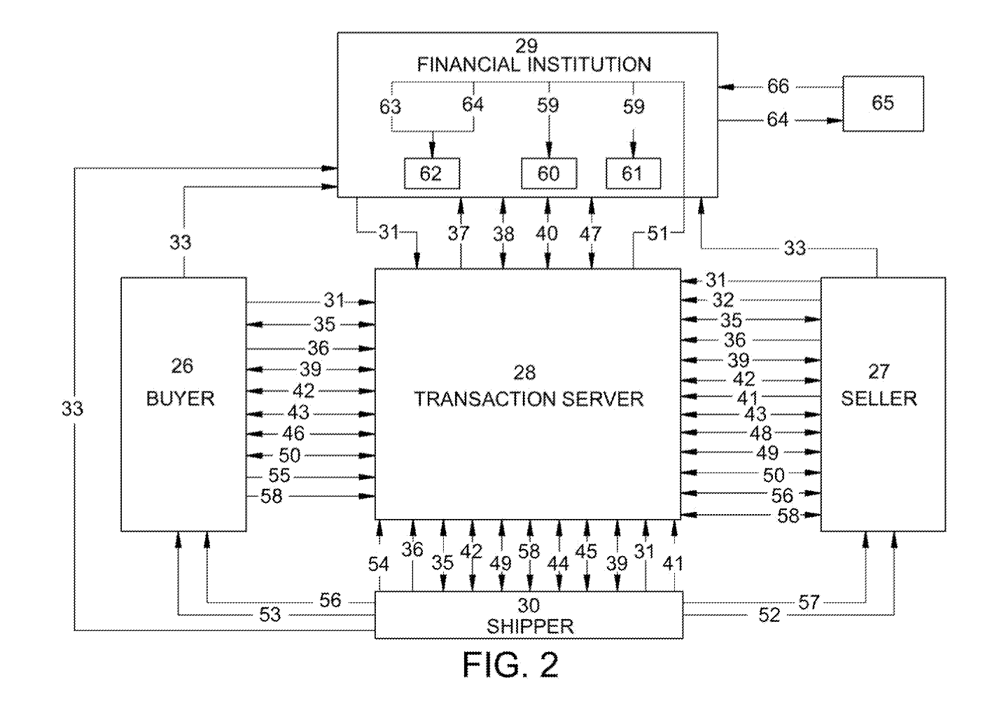

FIG. 2 shows a flow diagram of an example embodiment of the method object of the present invention. The method described in this example embodiment would include a carrier (30) for the good requested by the buyer (26) in order to deliver it. Please note that the carrier figure is optional, since this transportation service may be provided by the supplier or the buyer himself. Furthermore, when a service has been contracted rather than a good, the carrier figure is not necessary.

It is also important to note that the carrier FIG. 26) and the supplier FIG. 27) in the flow diagram representing them, may be interchangeable, insofar as that a buyer is also usually a supplier. Firstly, the financial entities (29) (for example banks), the buyers (26) (for example companies, individuals or private users), the suppliers (27) (for example companies, individuals or private users) and carriers (30) (for example companies, individuals or private users) register (31) in the transactions server (28) and their prior acceptation of the contract proposed by the method or system wherein they accept certain system conditions of use. The server (28) has an interface, for example a web-page, via which the banks (29), buyers (26), suppliers (27) and carriers (30) perform each and every one of the method phases. The web page will give them the option, in the registration phase itself (31) or later, to enter office or delegation data etc., a catalogue of their products (with characteristics, photos, videos etc.) a price list, the services they offer and their rates (for urgent transport, usual rates, etc) and other information required by the user. Clearly, including this information from the moment they register is beneficial to them, since web uses will have immediate access to this information. It also offers the possibility of entering permissions to certain people so that they can manage specific aspects of the transactions. For example a bank could give permission to certain people from certain offices in order to perform specific tasks, such as the authorization to give purchase credits. All information registered in the transactions server will be protected by the web security mechanisms, in order to guarantee complete confidentiality.

The suppliers (27) and carriers (30) should also specify their standard conditions of sale and timeframes (41) which are then stored in the transactions server (28).

In these conditions of sale, the supplier (27) and carrier (30) will have initially introduced their standard conditions and timeframes, which is mandatory for them and the buyer (26), in order to perform a transaction. These conditions may be negotiated (42) with the buyer (27), for all transactions or for each transaction. Agreed amendments in the standard conditions and timeframes are also stored in the transactions server (28).

Only that information which the registered user authorizes shall be published on the web. Therefore, for example, a list of registered banks may be published on the web as well as information authorized by them, for example the countries in which they operate, offices, office information etc. Equally, only that information pertaining to the registered suppliers authorized by them is published, for example the countries in which they operate, delegations, delegation information, their products and product characteristics, the category to which they pertain, etc. The same applies to carriers as in previous cases, publishing authorized information on the services they offer, their rates, the countries in which they operate offices, office information, etc.

The buyer (26), the supplier (27) and the carrier (30) may select from the general list published on the web between all of them, those with whom they work or usually work and store (34) this selection in the transactions server (28).

For example, information on their banks and offices with which they usually work, on “their” suppliers and “their” carriers. More contacts can always be added to said selection.

All those requesting purchase credits from a bank must have opened their respective current accounts (33) in said bank.

The buyer (26), the supplier (27) and the carrier (30) should request to open current accounts (33) in order to be able to request purchase credits (36) via the transaction server (28), from at least one of the registered banks (29). The buyer may request several credits from several financial entities, always via the transactions server, depending on the same being granted exclusively by the financial entities.

The buyer may negotiate purchase credits with the bank, the amount of said purchase credits, interest on the credit used, the expiry timeframe of the credit etc. via the server itself or outside the server, however once an agreement has been made, the granting of the credits and the amount and conditions of said credits will always be made by means of the transactions server. This information will remain under strict confidentiality and protected by the high security web mechanisms.

The server (28) resends (37) the purchase credit request to the bank (29) selected by the buyer (26), the supplier (27) and the carrier (30) who returns (38) the granting or non-granting of the purchase credits to the server (28) along with the conditions agreed between the bank (29) and each one of them, once accepted (39) by the buyer (26), supplier (27) and the carrier (30) also via the server (28), involving the availability (40) of the purchase credits only for purchases made via the web.

The following method phase, considered to be optional, is the buyer (26) applying (43) a budget to the supplier (27) based on an expected order which is sent to the buyer (26) via the transactions server (28). If the service of a carrier (30) is required in the budget, the web page may contain fields in which to enter information exclusive to the carrier (30) in which the supplier (27) may select the desired carrier and introduce the specific data to produce a budget, as well as a collection point, a delivery point, the weight of the good, the number of packages, the type of service, etc. The budget request (44) will be delivered to the carrier (30) automatically via the web. The carrier (30) will enter the budget in the reserved fields within the established timeframe.

When this budget or proposed order becomes a concrete order by accepting the buyer (27) and supplier (26) said budget, the carrier (30) now knows that he has a concrete service order, for an approximate date, according to the delivery timeframe confirmed by the supplier (26) and that he will perform the service when the supplier (26) notifies him (45) via the transactions server (28) of the collection day.

Following the total or partial acceptation, via the web page of the transactions server (28) of the budgets related to the order and transport, by all the parties involved, the order (46) is generated automatically. Please note that if the buyer accepts part of the budget generated by the supplier, the supplier should accept this part of the accepted budget. Then an order (46) is automatically generated for the part of the budget accepted, this order being considered accepted by both parties. The buyer will assign (47), via the transactions server, purchase credits to the transaction. The transactions server (28) will then check that the buyer (26) has been assigned with purchase credits for an amount less than or equal to that of the order made and will automatically block it temporarily. If they do not have enough purchase credits, the order will automatically not be accepted. The case may be that after a buyer has only accepted part of the budget, the supplier is no longer interested in delivering the resulting order. Therefore, if the method does not register the buyer's total or partial acceptation of the budget given or the suppliers subsequent acceptation of this budget, everything being within the established timeframes, the budget is dismissed.

If the buyer (26) does not request a budget, an order (26) will be generated via the transactions server (28) directly which may be accepted (48) either totally or partially by the supplier (27). The supplier (27) may accept only part of the order therefore the buyer (26) should confirm the order accepted by the supplier. They buyer (26) will assign (47) purchase credits to the transaction via the transactions server (28). Once again the system will check that the buyer (26) has assigned purchase credits for an amount less than or equal to that of the order placed and will automatically block the credits assigned for a temporary period. If the buyer (26) does not have enough purchase credits, the order will automatically be dismissed.

The supplier (27) and carrier (30) will generate respective delivery notes (49) for the order made and for the transport of the order. These delivery notes (50) will be accepted totally or partially (26) via the server (28) by the buyer in the case of the order or by the by the buyer (26) or supplier (27) in the case of transport. The delivery notes issuer should subsequently confirm the acceptation of the same via the web server (28). All these acceptations should be made within the previously agreed timeframe for accepting delivery notes. Should the buyer (26) not accept the delivery note within the established timeframe, the transactions server (28) will automatically send instructions (51) to the bank (29) to pay the supplier (27) the total amount corresponding to the order placed. The amount on said delivery note will be subsequently subtracted from the buyer's (26) purchase credits, which were previously blocked.

If the buyer (26) accepts the delivery note totally or partially within the timeframe agreed for accepting the delivery note, the transactions server (28) will automatically send instructions (51) to the bank (29) to pay the supplier (27) the amount of the accepted part of the delivery note and subtract the amount of said accepted part of the delivery note from the buyer's purchase credits which were previously blocked, keeping the amount corresponding to the part of the delivery note not accepted by the buyer blocked from their purchase credits.

In the order phase (46), the carrier (30) collects (52) the order placed from the supplier's (27) facilities and delivers (53) the same, within the established time frame, to the buyer (26). The carrier will inform (54) the server (28) of the delivery once it has been made.

When the buyer (26) has received the order, he has the option of making a total or partial (55) return of the good received. The return of the good received could be made because it does not fit what was requested or because said good does not comply with the agreed conditions. Said return is made by the buyer (26) which informs the supplier (27), via the transactions server (28) and within the agreed timeframe for making returns, of the existence of an incident in the good received. The conditions of return may be negotiated (56) between the buyer (26) and supplier (27) and will once again involve the carrier (30) who will be responsible for collecting (56) the good returned from the buyer (26) and delivering (57) the same to the supplier (27). Furthermore, the return may be made with or without replacement.

Finally, the transactions server (28) optionally generates invoices (58) for the amounts corresponding to the orders or services delivered, to which the buyer (26), supplier (27) and carrier (30) may access.

When the transactions server (28) sends instructions (51) to the financial institution (29), the bank, to make a payment to the supplier or carrier, said bank will make the corresponding payments (59) into the suppliers account (61) and into the carriers account (60). At the same time, the bank (29) will credit, in the case of the buyer paying the carrier, the buyers current account (62) corresponding to their own purchase credits (63) used in the transaction and to the interest on said purchase credits (64).

A negotiation mechanism is proposed for suppliers (27), carriers (30) and buyers (26) who do not pay when their purchase credit expiry, with the bank (29). Said negotiation mechanism establishes a way of repaying the unpaid purchase credit, via the transactions server (28), before the bank (29) takes legal action

At the same time, in order to guarantee that the financial entities (29) are covered for the purchase credits in default, it has been established that a small percentage are automatically taken away from the amount payable to the supplier for transaction, established as in contract and contributions are made to a secure payment fund (65). Using this secure payment fund (65) the system will assume (66) part of the purchase credits in default in the financial entities.

1. A method for performing at least one commercial transaction between at least one buyer and at least one supplier, the commercial transaction involving a transactions server, the buyer, the supplier, and at least one lender, the transactions server including a user interface, the method comprising:
registering, in a database, the buyer, the supplier and the lender using the user interface, the user interface and the database being included within the transactions server;
establishing conditions of sale in order to perform the commercial transaction, the conditions of sale being established by the buyer or the supplier and being stored in the database, the conditions of sale including timeframes associated with steps that define the commercial transaction, wherein (i) the transactions server manages an indication of conformity or lack of conformity with each of the timeframes, the indication being made by the buyer, the supplier or the lender using the user interface and (ii) in a case where an indication of conformity, an indication of lack of conformity, or no indication of conformity or lack of conformity with one of the timeframes is made, the transactions server automatically performs an action to address the indication of conformity, the indication of lack of conformity, or the no indication of conformity or lack of conformity with the one of the timeframes;
requesting, by the buyer through the user interface, purchase credits from the lender for an amount and under conditions agreed with the lender;
generating, by the buyer through the user interface and after the purchase credits have been granted an order for goods or services with the supplier, the order being for an amount less than or equal to the total amount of purchase credits granted to the buyer, and temporarily blocking, using the transactions server, a portion of the purchase credits granted to the buyer equal to the amount of the order;
automatically instructing, using the transactions server the lender to pay the supplier a total or partial amount of a delivery note corresponding to delivered goods or services by the supplier to the buyer in accordance with the order, upon fulfilment of the conditions of sale or completion of a timeframe set for the buyer to give partial or total conformity to the delivery note, and deducting, using the transactions server, the total or partial payment from the portion of the purchase credits granted to the buyer blocked by the transactions server.

2. The method according to claim 1, further comprising:
in a case where the commercial transaction requires transportation of the order, selecting, by the buyer or the supplier through the user interface, a carrier which acts a secondary supplier and the buyer or the supplier acts a secondary buyer of a service provided by the carrier, the carrier being previously registered in the transactions server.

3. The method according to claim 1, wherein the steps that define the commercial transaction are selected from at least one or more of: (i) an order quote generation step; (ii) an order generation step; (iii) an order transport step; (iv) a delivery not generation step; and (v) an invoice generation step.

4. The method according to claim 1,
wherein the conditions of sale include conditions selected from at least: (i) designating a payer and a percentage of transport of the goods or services requested in the order to be paid by the payer; and (ii) designating a payer and a percentage of interest on the purchase credits granted to the buyer to be paid by the payer, and
wherein the timeframes are selected from at least: (i) a timeframe for the buyer to accept an order quote generated by the supplier; (ii) a timeframe for delivering an order placed by the buyer, the timeframe for delivering the order placed by the buyer being approved by the buyer; (iii) a timeframe for the supplier to accept the order placed by the buyer; (iv) a timeframe for the buyer to total or partially accept the delivery note of the goods or services provided by the supplier; (v) a timeframe for the buyer to return the goods or services to the supplier; (vi) a timeframe for the supplier to accept the return made by the buyer; (vii) a timeframe for the supplier to accept the return with replacement made by the buyer; and (viii) a timeframe to negotiate a non-conformity between the buyer and the supplier.

5. The method according to claim 1, wherein the conditions of sale may be modified upon prior agreement of the buyer and the supplier, the modification being stored in the database.

6. The method according to claim 5, wherein extensions are set, through the transactions server, for any of the timeframes upon prior agreement of the buyer and the supplier.

7. The method according to claim 3, wherein if an order quote has been generated, the transactions server (i) verifies full or partial acceptation of the order quote by the buyer and the supplier within a timeframe for accepting the order quote, (ii) verifies that the portion of the purchase credits granted to the buyer blocked by the transactions server is greater than or equal to the total amount of the accepted part of the order quote, (iii) validates the accepted part of the order quote and stores the accepted part of the order quote in the database, and (iv) automatically generates an order to the supplier for the accepted part of the order quote.

8. The method according to claim 4, wherein if the buyer does not fully or partially accept the order quote within the timeframe for the buyer to accept the order quote generated by the supplier, the transactions server rejects the order quote.

9. The method according to claim 4, wherein if the supplier does not deliver the goods or services ordered by the buyer within the timeframe for delivering the order placed by the buyer, the transactions server rejects the commercial transaction and unblocks the previously blocked purchase credits granted to the buyer equal to the amount of the order.

10. The method according to claim 3, wherein if an order quote has been generated, the transactions server (i) verifies total or partial acceptation of the order quote by the buyer and the supplier within a timeframe for accepting the order quote, (ii) validates the accepted part of the order quote and stores the accepted part of the order quote in the database, and (iii) unblocks from the previously blocked purchase credits granted to the buyer equal to the amount corresponding to the non-accepted part of the order quote.

11. The method according to claim 3, wherein if an order is placed by the buyer and if the supplier does not accept the order within a timeframe for the supplier to accept the order, the transactions server rejects the commercial transaction and unblocks the previously blocked purchase credits granted to the buyer equal to the amount of the order.

12. The method according to claim 7, wherein the transactions server (i) checks whether the buyer has indicated total or partial conformity with the delivery note within a timeframe for accepting the delivery note, (ii) validates the accepted part of the delivery note and stores the accepted part of the delivery note in the database, and (iii) automatically instructs the lender to pay the supplier the amount of the approved part of the delivery note and deducts the amount of the approved part of the delivery note from the previously blocked purchase credits granted to the buyer the amount of the previously blocked purchase credits granted to the buyer corresponding to the part of the delivery note that has not been accepted by the buyer remaining blocked.

13. The method according to claim 7, wherein if the buyer does not indicate acceptance of the delivery note within a timeframe for accepting the delivery note, the transactions server (i) validates the entire delivery note and stores the entire delivery note in the database, and (iii) instructs the lender to pay the supplier the total amount of the order and deducts the total amount of the order from the previously blocked purchase credits granted to the buyer.

14. The method according to claim 10, wherein if the buyer does not totally or partially accept the delivery note and carries out a total or partial return of the goods or services received within a timeframe for returns, the transactions server (i) checks whether the supplier has indicated conformity with the return within a timeframe for accepting returns, (ii) cancels, in total or in part, the commercial transaction, and (iii) unblocks the amount of the previously blocked purchase credits granted to the buyer corresponding to the goods or services returned.

15. The method according to claim 10, wherein if the buyer carries out a total or partial return of the goods or services received with replacement within a timeframe for returns with replacement, the transactions server (i) checks whether the supplier has indicated conformity with the return within a timeframe for accepting returns with replacement, and (ii) maintains a temporary block on the amount of the previously blocked purchase credits granted to the buyers corresponding to the goods or services returned until the supplier replaces the returned goods or services within a timeframe previously accepted by the buyer and the supplier, and the buyer indicates conformity to a delivery note of the goods or services replaced within a timeframe for accepting the delivery note of the goods or services replaced.

16. The method according to claim 10, wherein if the buyer does not carry out a total or partial return of the goods or services received within a timeframe for returns, the transactions server instructs the lender to pay the supplier the amount of the delivery note by automatically deducting the amount of the delivery note from the previously blocked purchase credits granted to the buyer.

17. The method according to claim 4, further comprising:
in a case where a lack of conformity is indicated by the buyer or the supplier and a timeframe for negotiating the lack of conformity, which is previously set in the conditions of sale, has elapsed, requesting a mediation process by a qualified person to resolve lack of conformity, the buyer and supplier agreeing to comply with the resolution of the mediation process.

18. The method according to claim 4, wherein the transactions server records the timeframes from a date selected from: (i) a date of indication of a conformity or a nonconformity by the buyer, supplier or lender; (ii) a date of an order quote, an order, a delivery or a return generation; and (iii) an expiry date of a previous timeframe.

19. The method according to claim 1, wherein the transactions server assigns an identifier to each commercial transaction.

20. The method according to claim 1, wherein in the registering of the supplier, the supplier provides a catalogue of goods and services on sale, the catalogue being stored in the database.

21. The method according to claim 1, wherein when the buyer has been granted more than one purchase credit before placing an order, apart of the amount of the order that passes on each purchase credit is selected.

22. The method according to claim 1, wherein the transactions server deducts a percentage from the amount to be paid to the supplier that is deposited into a reserve fund as a payment guarantee for the lender of the granted purchase credits.

23. The method according to claim 4, wherein, before a timeframe elapses, the transactions server sends a notification to each party involved in the timeframe.

24. A systemfor performing at least one commercial transaction between at least one buyer and at least one supplier and involving at least one lender, the system comprising:
a transactions server including (i) a database storing data from registered buyers, suppliers and lenders, conditions of sale established by the suppliers, state of the transactions and catalogues of goods and services sold by the suppliers, and (ii) a user interface through which buyers, suppliers and lenders interact with the transactions server; and
wherein the transactions server further includes a central processor and a central memory in communication of the central processor and storing executable instruction, which when executed by the central processor cause the transactions server to:
register, in the database, the buyer, the supplier and the lender using the user interface;
establish conditions of sale in order to perform the commercial transaction, the conditions of sale being established by the buyer or the supplier and being stored in the database, the conditions of sale including timeframes associated with steps that define the commercial transaction, wherein (i) the transactions server manages an indication of conformity or lack of conformity with each of the timeframes, the indication being made by the buyer, the supplier or the lender using the user interface and (ii) in a case where an indication of conformity, an indication of lack of conformity, or no indication of conformity or lack of indication of conformity with one of the timeframes is made, the transactions server automatically performs an action to address the indication of conformity, the indication of lack of conformity, or the no indication of conformity or lack of indication of conformity with the one of the timeframes;
request, by the buyer through the user interface, purchase credits from the lender for an amount and under conditions agreed with the lender;
generate, by the buyer through the user interface and after the purchase credits have been granted, an order for goods or services with the supplier, the order being for an amount less than or equal to the total amount of purchase credits granted to the buyer, and temporarily block a portion of the purchase credits granted to the buyer equal to the amount of the order;
automatically instruct the lender to pay the supplier a total or partial amount of a delivery note corresponding to delivered goods or services by the supplier to the buyer in accordance with the order, upon fulfilment of the conditions of sale or completion of a timeframe set for the buyer to give partial or total conformity to the delivery note, and deduct the total or partial payment from the previously blocked purchase credits granted to the buver.

25. The system according to claim 24, wherein in a case where the commercial transaction requires transportation of the order, the transaction server selects, by the buyer or the supplier through the user interface, a carrier which acts a secondary supplier and the buyer or the supplier acts a secondary buyer of a service provided by the carrier, the carrier being previously registered in the transactions server.

26. The system according to claim 24, wherein the steps that define the commercial transaction are selected from at least one or more of: (i) an order quote generation step; (ii) an order generation step; (iii) an order transport step; (iv) a delivery not generation step; and (v) an invoice generation step.

27. The system according to claim 24,
wherein the conditions of sale include conditions selected from at least: (i) designating a payer and a percentage of transport of the goods or services requested in the order to be paid by the payer; and (ii) designating a payer and a percentage of interest on the purchase credits granted to the buyer to be paid by the payer, and
wherein the timeframes are selected from at least: (i) a timeframe for the buyer to accept an order quote generated by the supplier; (ii) a timeframe for delivering an order placed by the buyer, the timeframe for delivering the order placed by the buyer being approved by the buyer; (iii) a timeframe for the supplier to accept the order placed by the buyer; (iv) a timeframe for the buyer to total or partially accept the delivery note of the goods or services provided by the supplier; (v) a timeframe for the buyer to return the goods or services to the supplier; (vi) a timeframe for the supplier to accept the return made by the buyer; (vii) a timeframe for the supplier to accept the return with replacement made by the buyer; and (viii) a timeframe to negotiate a non-conformity between the buyer and the supplier.

28. The system according to claim 24, wherein the conditions of sale may be modified upon prior agreement of the buyer and the supplier, the modification being stored in the database.

29. The system according to claim 28, wherein extensions are set, through the transactions server, for any of the timeframes upon prior agreement of the buyer and the supplier.

30. The system according to claim 26, wherein if an order quote has been generated, the transactions server (i) verifies full or partial acceptation of the order quote by the buyer and the supplier within a timeframe for accepting the order quote, (ii) verifies that the previously blocked purchase credits granted to the buyer is greater than or equal to the total amount of the accepted part of the order quote, (iii) validates the accepted part of the order quote and stores the accepted part of the order quote in the database, and (iv) automatically generates an order for the accepted part of the order quote.

31. The system according to claim 27, wherein if the buyer does not fully or partially accept the order quote within the timeframe for the buyer to accept the order quote generated by the supplier, the transactions server rejects the order quote.

32. The system according to claim 27, wherein if the supplier does not deliver the goods or services ordered by the buyer within the timeframe for delivering the order placed by the buyer, the transactions server rejects the commercial transaction and unblocks the previously blocked purchase credits granted to the buyer equal to the amount of the order.

33. The system according to claim 26, wherein if an order quote has been generated, the transactions server (i) verifies total or partial acceptation of the order quote by the buyer and the supplier within a timeframe for accepting the order quote, (ii) validates the accepted part of the order quote and stores the accepted part of the order quote in the database, and, (iii) unblocks from the previously blocked purchase credits granted to the buyer equal to the amount corresponding to the non-accepted part of the order quote.

34. The system according to claim 26, wherein if an order is placed by the buyer and if the supplier does not accept the order within a timeframe for the supplier to accept the order, the transactions server rejects the commercial transaction and unblocks the previously blocked purchase credits granted to the buyer equal to the amount of the order.

35. The system according to claim 30, wherein the transactions server (i) checks whether the buyer has indicated total or partial conformity with the delivery note within a timeframe for accepting the delivery note, (ii) validates the accepted part of the delivery note and stores the accepted part of the delivery note in the database, and (iii) automatically instructs the lender to pay the supplier the amount of the approved part of the delivery note and deducts the amount of the approved part of the delivery note from the previously blocked purchase credits granted to the buyer, the amount of the previously blocked purchase credits granted to the buyer corresponding to the part of the delivery note that has not been accepted by the buyer remaining blocked.

36. The system according to claim 30, wherein if the buyer does not indicate acceptable of the delivery note within a timeframe for accepting the delivery note, the transactions server (i) validates the entire delivery note and stores the entire delivery note in the database, and (iii) instructs the lender to pay the supplier the total amount of the order and deducts the total amount of the order from the previously blocked purchase credits granted to the buyer.

37. The system according to claim 33, wherein if the buyer does not totally or partially accept the delivery note and carries out a total or partial return of the goods or services received within a timeframe for returns, the transactions server (i) checks whether the supplier has indicated conformity with the return within a timeframe for accepting returns, (ii) cancels, in total or in part, the commercial transaction, and (iii) unblocks the amount of the previously locked purchase credits granted to the buyer corresponding to the goods or services returned.

38. The system according to claim 33, wherein if the buyer carries out a total or partial return of the goods or services received with replacement within a timeframe for returns with replacement, the transactions server (i) checks whether the supplier has indicated conformity with the return within a timeframe for accepting returns with replacement, and (ii) maintains a temporary block on the amount of the previously blocked purchase credits granted to the buyer corresponding to the goods or services returned until the supplier replaces the returned goods or services within a timeframe previously accepted by the buyer and the supplier, and the buyer indicates conformity to a delivery note of the goods or services replaced within a timeframe for accepting the delivery note of the goods or services replaced.

39. The system according to claim 33, wherein if the buyer does not carry out a total or partial return of the goods or services received within a timeframe for returns, the transactions server instructs the lender to pay the supplier the amount of the delivery note by automatically deducting the amount of the delivery note from the previously blocked purchase credits granted to the buyer.

40. The system according to claim 27, wherein in a case where a lack of conformity is indicated by the buyer or the supplier and a timeframe for negotiating the lack of conformity, which is previously set in the conditions of sale, has elapsed, the transaction server requests mediation by a qualified person to resolve lack of conformity, the buyer and supplier agreeing to comply with the resolution of the mediation.

41. The system according to claim 27, wherein the transactions server records the timeframes from a date selected from: (i) a date of indication of a conformity or a nonconformity by the buyer, supplier or lender; (ii) a date of an order quote, an order, a delivery or a return generation; and (iii) an expiry date of a previous timeframe.

42. The system according to claim 24, wherein the transactions server assigns an identifier to each commercial transaction.

43. The system according to claim 24, wherein in the registering of the supplier, the supplier provides a catalogue of goods and services on sale, the catalogue being stored in the database.

44. The system according to claim 24, wherein when the buyer has been granted more than one purchase credit before placing an order, the part of the amount of the order that passes on each purchase credit is selected.

45. The system according to claim 24, wherein the transactions server deducts a percentage from the amount to be paid to the supplier that is deposited into a reserve fund as a payment guarantee for the lender of the granted purchase credits.

46. The system according to claim 27, wherein, before a timeframe elapses, the transactions server sends a notification to each party involved in the timeframe.

47. The method according to claim 4, wherein if an order quote has been generated, the transactions server (i) verifies total or partial acceptation of the order quote by the buyer and the supplier within the timeframe for the buyer to accept the order quote, (ii) validates the accepted part of the order quote and stores the accepted part of the order quote in the database, and (iii) unblocks from the previously blocked purchase credits granted to the buyer equal to the amount corresponding to the non-accepted part of the order quote.

48. The method according to claim 4, wherein if an order is placed by the buyer and if the supplier does not accept the order within the timeframe for the supplier to accept the order, the transactions server rejects the commercial transaction and unblocks the previously blocked purchase credits granted to the buyer equal to the amount of the order.

49. The method according to claim 10, wherein the transactions server (i) checks whether the buyer has indicated total or partial conformity with the delivery note within a timeframe for accepting the delivery note, (ii) validates the accepted part of the delivery note and stored the accepted part of the delivery note in the database, and (iii) automatically instructs the lender to pay the supplier the amount of the approved part of the delivery note and deducts the amount of the approved part of the delivery note from the previously blocked purchase credits granted to the buyer the amount of the previously blocked purchase credits granted to the buyer corresponding to the part of the delivery note that has not been accepted by the buyer remaining blocked.

50. The method according to claim 10, wherein if the buyer does not indicate acceptable of the delivery note within a timeframe for accepting the delivery note, the transactions server (i) validates the entire delivery note and stored the entire delivery note in the database, and (ii) instructs the lender to pay the supplier the total amount of the order and deducts the total amount of the order from the previously blocked purchase credits granted to the buyer.

51. The method according to claim 12, wherein if the buyer does not totally or partially accept the delivery note and carries out a total or partial return of the goods or services received within a timeframe for returns, the transactions server (i) checks whether the supplier has indicated conformity with the return within a timeframe for accepting returns, (ii) cancels, in total or in part, the commercial transaction, and (iii) unblocks the amount of the previously blocked purchase credits granted to the buyer corresponding to the goods or services returned.

52. The method according to claim 12, wherein if the buyer carries out a total or partial return of the goods or services received with replacement within a timeframe for returns with replacement, the transactions server (i) checks whether the supplied has indicated conformity with the return within a timeframe for accepting returns with replacement, and (ii) maintains a temporary block on the amount of the previously blocks purchase credits granted to the buyer corresponding to the goods or services returned until the supplier replaces the returned goods or services within a timeframe previously accepted by the buyer and the supplier, and the buyer indicates conformity to a delivery note of the goods or services replaced within a timeframe for accepting the delivery note of the goods or services replaced.

53. The method according to claim 12, wherein if the buyer does not carry out a total or partial return of the goods and services received within a timeframe for returns, the transactions server instructs the lender to pay the supplier the amount of the delivery note by automatically deducting the amount of the delivery note from the previously blocks purchase credits granted to the buyer.

54. The system according to claim 27, wherein if an order quote has been generated, the transactions server (i) verifies total or partial acceptation of the order quote by the buyer and the supplier within the timeframe for the buyer to accept the order quote, (ii) validates the accepted part of the order quote and stored the accepted part of the order quote in the database, and (iii) unblocks from the previously blocked purchase credits granted to the buyer equal to the amount corresponding to the non-accepted part of the order quote.

55. The system according to claim 27, wherein if an order is placed by the buyer and if the supplier does not accept the order within the timeframe for the supplier to accept the order, the transactions server rejects the commercial transaction and unblocks the previously blocked purchase credits granted to the buyer equal to the amount of the order.

56. The system according to claim 33, wherein the transactions server (i) checks whether the buyer has indicated total or partial conformity with the delivery note within a timeframe for accepting the delivery note, (ii) validates the accepted part of the delivery note and stored the accepted part of the delivery note in the database, and (iii) automatically instructs the lender to pay the supplier the amount of the approved part of the delivery note and deducts the amount of the approved part of the delivery note from the previously blocked purchase credits granted to the buyer, the amount of the previously blocked purchase credits granted to the buyer corresponding to the part of the delivery note that has not been accepted by the buyer remaining blocked.

57. The system according to claim 33, wherein if the buyer does not indicate acceptance of the delivery note within a timeframe for accepting the delivery note, the transactions server (i) validates the entire delivery note and stored the entire delivery note in the database, and (iii) instructs the lender to pay the supplier the total amount of the order and deducts the total amount of the order from the previously blocked purchase credits granted to the buyer.

58. The system according to claim 35, wherein if the buyer does not totally or partially accept the delivery note and carries out a total or partial return of the goods or services received within a timeframe for returns, the transactions server (i) checks whether the supplier has indicated conformity with the return within a timeframe for accepting returns, (ii) cancels, in total or in part, the commercial transaction, and (iii) unblocks the amount of the previously blocks purchase credits granted to the buyer corresponding to the goods or services returned.

59. The system according to claim 35, wherein if the buyer carries out a total or partial return of the goods or services received with replacement within a timeframe for returns with replacement, the transactions server (i) checks whether the supplier has indicated conformity with the return within a timeframe for accepting a return with replacement, and (ii) maintains a temporary block on the amount of the previously blocked purchase credits granted to the buyer corresponding to the goods or services returned, until the supplier replaces the returned goods or services within a timeframe previously accepted by the buyer and the supplier, and the buyer indicates conformity to a delivery note of the goods or services replaced within a timeframe for accepting the delivery note of the goods or services replaced.

60. The according to claim 35, wherein if the buyer does not carry out a total or partial return of the goods or services within a timeframe for returns, the transactions server instructs the lender to pay the supplier the amount of the delivery note by, automatically deducting the amount of the delivery note from the previously blocked purchase credits granted to the buyer.
